(19) United States
(12) Patent Application Publication
(10) Pub. No.: US 2014/0259635 A1
(43) Pub. Date: Sep. 18, 2014

(54) ASSEMBLY MACHINE OF ROTATING ELECTRICAL MACHINE AND METHOD FOR MANUFACTURING ROTATING ELECTRICAL MACHINE

(71) Applicant: Kabushiki Kaisha Toshiba, Minato-ku (JP)

(72) Inventors: Toshikazu TAKI, Kanagawa-ken (JP); Tomohiro Kita, Kanagawa-ken (JP); Yukihiro Ikeya, Kanagawa-ken (JP); Mitsuhiro Fujii, Kanagawa-ken (JP); Mineaki Iida, Kanagawa-ken (JP)

(73) Assignee: Kabushiki Kaisha Toshiba, Minato-ku (JP)

(21) Appl. No.: 14/025,928

(22) Filed: Sep. 13, 2013

(30) Foreign Application Priority Data
Mar. 14, 2013 (JP) 2013-052526

(51) Int. Cl. H02K 15/04

(52) U.S. Cl. CPC H02K 15/0464
USPC 29/596; 29/732

(57) ABSTRACT

According to one embodiment, an assembly machine of a rotating electrical machine includes: a coil alignment portion that aligns coils, when aligning coils in a ring shape, such that one side of a circumferential direction in the ring is made to lay over a top surface side of an adjacent coil, and the other side of the circumferential direction of the coils is made to lay under a bottom surface side of an adjacent coil so as to form mutually overlapping regions in a thickness direction between the adjacent coils; an insertion part having columnar parts inserted into the interior of the mutually overlapping regions; and a pressing part which inserts the insertion part in an axial direction thereof, mutually overlapping in the thickness direction between the adjacent coils, from the insertion part into the interior of a slot in the core of the rotating electrical machine.

### CROSS-REFERENCE TO RELATED APPLICATIONS

This application is based upon and claims the benefit of priority from Japanese Patent Application No. 2013-052526, filed on Mar. 14, 2013; the entire contents of which are incorporated herein by reference.

### FIELD

Embodiments described herein relate generally to an assembly machine of rotating electrical machine and a method for manufacturing rotating electrical machine.

### BACKGROUND

Stator winding for an electric motor, electric generator, and other rotating electrical machines is formed by distributed winding that inserts a coil formed in advance in a loop shape to span a plurality of teeth in a stator core.

Moreover, distributed winding includes concentric winding and lap winding.

Concentric winding concentrically arrays coils for each phase in order from the outside diameter of the stator. Therefore, because the coils for each phase are inserted to span teeth in sequential order from the outside diameter, assembly of the coil onto the stator core is easy.

Here, if the lengths of each coil winding is not the same, there is poor balance for each phase which causes noise and vibration. Therefore, the lengths of each coil winding are generally made to match.

However, in concentric winding, matching lengths for the winding of each coil increases the excess portion of the coil that extends to the outside in the axial direction of the stator core for the coil positioned on the inner side of the stator core. On account of this, there is a risk of degrading efficiency and/or increasing the size of the rotating electrical machine.

Conversely, with lap winding, the coils of each phase are laid out in a spiral. Therefore, even if the lengths of the coil windings for each phase match, the excess portion of the coil that extends to the outside in the axial direction of the stator core can be reduced. As a result, the efficiency of the rotating electrical machine can be improved.

However, lap winding having each phase coils laid out in a spiral have a problem in that it is difficult to assemble the coil onto the stator core using a machine.

For this, an assembly machine for assembling a coil to be in a lap winding configuration is proposed while seeking further improvement in production efficiency.

### BRIEF DESCRIPTION OF THE DRAWINGS

FIG. 1 is a schematic plan view for illustrating an assembly machine of a rotating electrical machine according to an embodiment;

FIG. 2 is a schematic perspective view for illustrating a coil alignment portion;

FIG. 3 is a schematic perspective view for illustrating a coil guide portion;

FIG. 4 is a schematic perspective view for illustrating a coil assembly portion;

FIG. 5 is a schematic perspective view for illustrating a reception of a set of aligned coils;

FIG. 6 is a schematic plan view for illustrating the reception of the set of aligned coils;

FIG. 7 is a schematic perspective view for illustrating assembly of a set of coils;

FIGS. 8A to 8D are schematic views for illustrating coil alignment portion according to another embodiment;

FIG. 9 is a schematic diagram showing a transfer portion;

FIGS. 10A to 10D are schematic views for illustrating coil guide portion according to another embodiment; and

FIGS. 11A to 11C are schematic views for illustrating the coil alignment portion according to another embodiment.

### DETAILED DESCRIPTION

In general, according to one embodiment, an assembly machine of a rotating electrical machine includes: a coil alignment portion that aligns a plurality of coils, when aligning the plurality of coils in a ring shape, such that one side of a circumferential direction in the ring shaped alignment of the coils is made to lay over a top surface side of an adjacent coil, and the other side of the circumferential direction of the coils is made to lay under a bottom surface side of an adjacent coil so as to form mutually overlapping regions in a thickness direction between the adjacent coils; an insertion part having a plurality of columnar parts inserted into the interior of the mutually overlapping regions; and a pressing part which inserts the insertion part in an axial direction thereof so as to push the plurality of coils, mutually overlapping in the thickness direction between the adjacent coils, from the insertion part into the interior of a slot in the core of the rotating electrical machine.

In general, according to another embodiment, a method for manufacturing a rotating electrical machine, includes: aligning the plurality of coils, when aligning a plurality of coils in a ring shape, such that one side of a circumferential direction in the ring shaped alignment of the coils is made to lay over a top surface side of an adjacent coil, and the other side of the circumferential direction of the coils is made to lay under a bottom surface side of an adjacent coil so as to form mutually overlapping regions in a thickness direction between the adjacent coils; inserting columnar parts respectively into an interior of the mutually overlapping regions; and pushing the plurality of coils, mutually overlapping in the thickness direction between the adjacent coils, from the columnar part into the interior of a slot in a core of the rotating electrical machine.

Embodiments will now be described with reference to the drawings. Note that the same numerals are applied to similar constituent elements in the drawings and detailed descriptions of such constituent elements are appropriately omitted.

Further, in the drawings below, coil 101 is depicted in an annular shape for ease in viewing the figure. The coil 101, for example, can be configured as a coil where both end portions of the winding protrudes from a loop portion formed by winding the winding.

Note that, in the following, an assembly of a coil configured to make a lap winding in a stator core of an electric motor will be described as one example, but the example will not be limited to this.

This example can be applied to, for example, assembling a coil to be a lap winding in a rotor core of an electric motor, assembling a coil to be a lap winding in a stator core of an electric generator, and the like. In other words, this invention has broad application in rotating electrical machines where a coil is assembled so as to be in a lap winding.

FIG. 1 is a schematic plan view for illustrating an assembly machine 1 of a rotating electrical machine according to this embodiment. FIG. 2 is a schematic perspective view for illustrating a coil alignment portion 20. FIG. 3 is a schematic perspective view for illustrating a coil guide portion 25 (corresponding to one example of a first coil guide portion).

Note that, in FIG. 3, a portion that includes a flat surface near the peripheral end of the coil guide portion 25 is omitted so that the guide portion 25b may be viewed more easily.

FIG. 4 is a schematic perspective view for illustrating a coil assembly portion 30.

As illustrated in FIG. 1, the assembly machine 1 of the rotating electrical machine is provided with a conveyor portion 10, the coil alignment portion 20, and the coil assembly portion 30.

The conveyor portion 10 conveys the coil guide portion 25, where a set of aligned coils 101 are placed, from the coil alignment portion 20 to the coil assembly portion 30. Further, the conveyor portion 10 passes the set of coils 101 to an insertion part 34a of the coil assembly portion 30, and after the coil 101 is assembled in the stator core 102, the coil guide portion 25 is conveyed from the coil assembly portion 30 to the coil alignment portion 20.

The conveyor portion 10 is provided with a drive part 11 and an arm part 12.

The drive part 11, via the arm part 12, drives the coil guide portion 25 to go and return between the coil alignment portion 20 and the coil assembly portion 30.

The drive part 11 may be provided with, for example, an indexing unit (an intermittent indexing device) using a cam, and/or a servo motor or other control motor.

An output shaft 11a of the drive part 11 is attached to a central portion of the arm part 12. A coil guide portion 25 is provided on both end portions respectively of the arm part 12. The coil guide portion 25 is provided via a bearing (not illustrated), and the coil guide portion 25 is configured to be able to rotate around the central axis of the coil guide portion 25.

Furthermore, it is configured to be able to hold a position in the rotation direction of the coil guide portion 25 by a braking device (not illustrated).

The coil alignment portion 20 places the coils 101 on an inclined plane 25b1 of the coil guide portion 25 and aligns the placed plurality of coils 101 in a predetermined configuration.

The coil alignment portion 20 aligns the plurality of coils 101 in a ring shape. At this time, one side of the circumferential direction in the ring shaped alignment of the coils 101 is made to lay over the top surface side of an adjacent coil. Moreover, the other side of the circumferential direction in the ring shaped alignment of the coils 101 is made to lay under the bottom surface side of an adjacent coil (see FIG. 6).

As illustrated in FIG. 2, the coil alignment portion 20 is provided with the coil guide portion 25, a coil storage part 21, a transfer part 22, a pushing part 23, and the drive part 24.

As illustrated in FIG. 3, the coil guide portion 25 is shaped like a disk. The insertion part 34a of the coil assembly portion 30 passes through a hole 25a provided in the central portion of the coil guide portion 25. A plurality of guide parts 25b are provided on one side of the coil guide portion 25. The guide parts 25b have an inclined plane 25b1 that inclines the coil 101 and the guide plane 25b2 that guides the coil 101 placed in an incline.

The inclined plane 25b1 is inclined in the same direction in the circumferential direction of the coil guide portion 25. The guide plane 25b2 is provided on the bottom end of the inclined plane 25b1. Therefore, as illustrated in FIG. 3, the position in the height direction of the coil 101 placed on the inclined plane 25b1 at the bottom end side, supported by the guide plane 25b2 and placed on the inclined plane 25b1 is lower than a position in the height direction of the adjacent coil 101 placed on the inclined plane 25b1 at the top end side.

Moving the plurality of coils 101 having this type of positional relationship to the central side of the coil guide portion 25 along the guide plane 25b2 allows a mutually overlapping region 101a (see FIG. 6) to be formed in the thickness direction between adjacent coils 101.

Note that the number and/or the disposed form of the inclined planes 25b1 is not restricted to this example and may be appropriately modified according to the number of the teeth 102b of the stator core 102 spanned by the coils 101.

The coil storage part 21 stacks and stores a plurality of coils 101. Further, a raising and lowering portion, not illustrated, is provided to fix a position in the height direction of the uppermost end of the stacked and stored coils 101. On account of this, when the coil 101 on the uppermost end is retrieved by the transfer part 22, the plurality of stacked and stored coils 101 are pushed up to a predetermined position in the height direction by the raising and lowering portion, not illustrated, and the coil 101 on the uppermost end can be retrieved by the transfer part 22.

The transfer part 22 retrieves the coil 101 on the uppermost end stored in the coil storage part 21, and the retrieved coil 101 is placed on the inclined plane 25b1 of the coil guide portion 25.

Note that, the coil 101 may not be required to always be placed on the inclined plane 25b1. For example, the coil 101 may be placed on a flat surface near the peripheral end of the coil guide portion 25.

The transfer part 22 may be, for example, a pick and place unit.

The transfer part 22 is provided with a chuck part 22a, raising and lowering part 22b, and a moving part 22c.

The chuck part 22a is provided on the raising and lowering part 22b. The chuck part 22a grasps the coil 101. The chuck part 22a may be, for example, an object having a pawl driven by an air cylinder.

The raising and lowering part 22b is provided on the moving part 22c. The raising and lowering part 22b moves to chuck part 22a in the raising and lowering direction (vertical direction).

The moving part 22c moves the chuck part 22a in the horizontal direction via the raising and lowering part 22b.

The raising and lowering part 22b and the moving part 22c may be, for example, a biaxially controlled robot.

The pushing part 23 moves the coil 101 placed on the inclined plane 25b1 of the coil guide portion 25 to the central side of the coil guide portion 25 along the guide plane 25b2. The pushing part 23 may have, for example, an air cylinder and a pawl provided on the tip end of the air cylinder.

The drive part 24 is provided below coil guide portion 25. The drive part 24 transfers motive power to the coil guide portion 25 located thereabove and rotates the coil guide portion 25 at a predetermined angle around the central axis of the coil guide portion 25. In other words, the drive part 24 intermittently rotates the coil guide portion 25 around the central axis of the coil guide portion 25 so that adjacent inclined planes 25b1 are positioned for placement of coils 101 by the transfer part 22.

An example of such a configuration includes a case where a ratchet mechanism (not illustrated) is provided on the coil guide portion 25, and a lever where a pawl of the ratchet mechanism is attached (not illustrated) is operated in a reciprocating manner by the drive part 24.

The drive part 24 may, for example, be provided with an air cylinder or the like.

The coil assembly portion 30 assembles the coils 101 so as to form a lap winding on the stator core 102.

The coil assembly portion 30 is provided with a stator core storage portion 31, a stator storage portion 32, a conveyor portion 33, and an assembly portion 34.

The stator core storage portion 31 stacks and stores a plurality of stator cores 102 prior to assembly of the coils 101. Further, a raising and lowering portion, not illustrated, is provided to fix a position in the height direction of the uppermost end of the stacked and stored stator cores 102. On account of this, when the stator core 102 on the uppermost end is retrieved by the transfer part 33, the plurality of stacked and stored stator cores 102 are pushed up by the raising and lowering portion, not illustrated, and the stator cores 102 on the uppermost end are moved to a position at a predetermined height.

The stator storage portion 32 stores the stator core 102 having the coil 101 assembled, which is to say the stator storage portion 32 stores the stator 100. The stator storage portion 32 stacks and stores a plurality of stators 100. Further, a raising and lowering portion, not illustrated, is provided to fix a position in the height direction of the uppermost end of the stacked and stored stators 100. On account of this, when the stators 100 are passed from the conveyor portion 33 to inside the stator storage portion 32, the plurality of stacked and stored stators 100 are lowered to a predetermined position in the height direction by the raising and lowering portion, not illustrated, so that the next stator 100 at the uppermost end can be placed.

The conveyor portion 33 retrieves the stator core 102 from the stator core storage portion 31 and conveys the stator core 102 to above the assembly portion 34. The conveyor portion 33 holds the stator core 102 while the coils 101 are assembled by the assembly portion 34. The conveyor portion 33 conveys the stator 100 (the stator core 102 having the coil 101 assembled) from above the assembly portion 34 to the stator storage portion 32 and passes the stator 100 to the stator storage portion 32.

The conveyor portion 33 is provided with a chuck part 33a, a raising and lowering part 33b, and a moving part 33c.

The chuck part 33a is provided on the raising and lowering portion 33b. The chuck part 33a grasps the stator core 102. The chuck part 33a may be, for example, an object having a pawl driven by a hydraulic cylinder.

The raising and lowering part 33b is provided on the moving part 33c. The raising and lowering part 33b moves the chuck part 33a in the raising and lowering direction.

The moving part 33c moves the chuck part 33a in the horizontal direction via the raising and lowering part 33b.

The raising and lowering part 33b and the moving part 33c may be, for example, a biaxially controlled robot.

The assembly portion 34 receives the set of aligned coils 101 from the coil guide portion 25 and assembles the set of aligned coils 101 onto the stator core 102.

The assembly portion 34 is provided below coil guide portion 25.

As illustrated in FIG. 4, the assembly portion 34 is provided with an insertion part 34a, a pressing part 34b, and a drive part 34c.

The insertion part 34a has a base section 34a1 and a plurality of columnar parts 34a2.

The base section 34a1 has a cylindrical shape. A hole that passes through the center of the base section 34a1 in the axial direction is configured to allow a shaft part 34b2 of the pressing part 34b to be inserted therethrough.

The plurality of columnar parts 34a2 is provided to protrude from the top end surface of the base section 34a1. The columnar parts 34a2 have a cylindrical shape and has a mating face 34a3 on the tip end side. The plurality of columnar parts 34a2 is respectively inserted into the interior of the mutually overlapping regions 101a.

The number of columnar parts 34a2 is the same as the number of teeth 102b of the stator core 102. Further, the disposed position of the columnar parts 34a2 is a position that faces the tip end section of the teeth 102b of the stator core 102, and the mating face 34a3 faces the tip end section of the teeth 102b when assembling the coils 101 onto the stator cores 102 (see FIG. 7).

The pressing part 34b presses the plurality of coils 101, mutually overlapping in the thickness direction between the adjacent coils 101, into the interior of slots 102a of the stator cores 102 from the insertion part 34a. The pressing part 34b has an end part 34b1 and a shaft part 34b2.

The end part 34b1 has a cylindrical shape.

The top end face 34b3 of the end part 34b1 is shaped in a convex curved surface.

The side surface of the end part 34b1 is provided with a convex part 34b4 that mutually protrudes between the columnar parts 34a2. The convex part 34b4 is configured so as to enter into the interior of the slot 102a when assembling the set of aligned coils 101 onto the stator core 102. An inclined plane 34b5 is provided on the top end of the convex part 34b4 to reduce resistance when pressing the coil 101 into the interior of the slot 102a.

The drive part 34c is configured so that the insertion part 34a and the pressing part 34b can be raised and lowered separately. For example, the drive part 34c may be provided with a raising and lowering device, not illustrated, that raises and lowers the insertion part 34a and a raising and lowering device, not illustrated, that raises and lowers the pressing part 34b.

Therefore, the insertion part 34a and the pressing part 34b may be raised by the drive part 34c to a predetermined position at the same time, and thereafter, only the pressing part 34b may be raised further to a predetermined position. Moreover, only the pressing part 34b may be lowered to a predetermined position, and thereafter, the insertion part 34a and the pressing part 34b may be lowered at the same time to a predetermined position.

Next, an operation of the assembly machine 1 of the rotating electrical machine according to this embodiment will be described together with a method for manufacturing the rotating electrical machine according to this embodiment.

First, the plurality of coils 101 are aligned in a predetermined configuration.

As illustrated in FIG. 2, the coil 101 on the uppermost end stored in the coil storage part 21 is retrieved by the transfer part 22, and the retrieved coil 101 is placed on the inclined plane 25b1 of the coil guide portion 25.

Note that, the coil 101 may not be required to always be placed on the inclined plane 25b1. For example, the coil 101 may be placed on a flat surface near the peripheral end of the coil guide portion 25.

Next, the coil guide portion 25 is intermittently rotated around the central axis of the coil guide portion 25 by the drive part 24 so that adjacent inclined planes 25b1 are positioned for placement of coils 101 by the transfer part 22.

Next, the coil 101 placed on the inclined plane 25b1 of the coil guide portion 25 is moved by the pushing part 23 to the central side of the coil guide portion 25 along the guide plane 25b2.

Then, subsequent repeating of the operation described above aligns the plurality of coils 101 so as to form the mutually overlapping regions 101a in the thickness direction between adjacent coils 101.

Note that, a configuration that places a coil 101 on all of the inclined planes 25b1 and then moves the coils 101 to the central side of the coil guide portion 25 is also possible.

Next, the coil guide portion 25, where a set of aligned coils 101 are placed, is conveyed by the conveyor portion 10 from the coil alignment portion 20 to the coil assembly portion 30. At this time, the coil guide portion 25, after having a set of coils 101 passed to the insertion part 34a of the coil assembly portion 30, is conveyed from the coil assembly portion 30 the coil alignment portion 20.

In other words, the coil guide portion 25 where the set of aligned coils 101 has been placed is supplied by the conveyor portion 10 to the coil assembly portion 30, while at the same time, the set of coils 101 is passed to the insertion part 34a of the coil assembly portion 30, and the coil guide portion 25 after having the coil 101 assembled onto the stator core 102 is supplied to the coil alignment portion 20.

Next, the stator core 102 is retrieved by the conveyor portion 33 from the stator core storage portion 31 and conveyed to above the assembly portion 34. The stator core 102 that has been conveyed to above the assembly portion 34 is held above the assembly portion 34 by the conveyor portion 33.

Next, the insertion part 34a and the pressing part 34b are raised by the drive part 34c of the assembly portion 34, and while held in an aligned state, the set of coils 101 is received by the columnar part 34a2 of the insertion part 34a. In other words, the set of coils 101 is received by the columnar part 34a2 of the insertion part 34a while holding a state in which mutually overlapping regions 101a are provided in the thickness direction between adjacent coils 101.

FIG. 5 is a schematic perspective view for illustrating the reception of the set of aligned coils 101.

FIG. 6 is a schematic plan view for illustrating the reception of the set of aligned coils 101.

As illustrated in FIGS. 5 and 6, raising the insertion part 34a inserts the columnar parts 34a2 of the insertion part 34a into interior of the mutually overlapping regions 101a in the thickness direction between adjacent coils 101. Therefore, further raising the insertion part 34a enables the set of aligned coils 101 to be received by the columnar parts 34a2 of the insertion part 34a while still in an aligned state.

Here, when configured according to that illustrated in FIG. 6, two columnar parts 34a2 are inserted into the interior of one coil 101. Therefore, when configured according to that illustrated in FIG. 6, as will be described below, the coil 101 is assembled so as to span two teeth 102b of the stator core 102.

For example, when assembling the coil 101 to span three or more teeth 102b of the stator core 102, a configuration may be made such that the columnar parts 34a2 of the insertion part 34a are respectively inserted one at a time into the interior of the mutually overlapping regions 101a on both sides of the one coil 101, and that the columnar parts 34a2 of the insertion part 34a also insert between the mutually overlapping regions 101a that are on both sides. Or, of the plurality of teeth 102b where the coil 101 is assembled, the columnar part 34a2 of the insertion part 34a may be provided in a position that corresponds to the position of the teeth 102b on both sides while the columnar part 34a2 of the insertion part 34a is not provided in a position that corresponds to the position of the teeth 102b that are between the teeth 102b on both sides.

Next, the set of coils 101 is assembled onto the stator core 102 while holding a state in which mutually overlapping regions 101a are provided in the thickness direction between adjacent coils 101.

FIG. 7 is a schematic perspective view for illustrating assembly of a set of coils 101. Note that, in FIG. 7, only a portion of the coils 101 is depicted in order to avoid complexity.

As illustrated in FIG. 7, further raising the insertion part 34a and the pressing part 34b by the drive part 34c of the assembly portion 34 makes the mating face 34a3 of the columnar part 34a2 face the tip end section of the teeth 102b.

Next, only the pressing part 34b is further raised by the drive part 34c. For example, the top end of the convex part 34b4 of the end part 34b1 of the pressing part 34b raises the pressing part 34b until protruding from the top end face of the stator core 102.

When doing so, because a plurality of convex parts 34b4 enter into the respective interiors of a plurality of slots 102a, the set of coils 101 are pushed into the interiors of the slots 102a of the stator core 102.

As described above, the coils 101 are assembled so as to form a lap winding on the stator core 102.

Next, the stator 100 (the stator core 102 having the coil 101 assembled) is conveyed by the conveyor portion 33 from above the assembly portion 34 to the stator storage portion 32 and passes the stator 100 to the stator storage portion 32.

Note that, in the assembly machine 1 of the rotating electrical machine according to this embodiment, aligning the plurality of coils 101 in a predetermined configuration by the coil alignment portion 20 enables simultaneous progression of the coils 101 to be assembled onto the stator cores 102 by the coil assembly portion 30.

Further, as described above, the method for manufacturing the rotating electrical machine according to this embodiment may include the following processes:

when aligning a plurality of coils 101 in a ring shape, a process that aligns the plurality of coils 101 such that one side of the circumferential direction in the ring shaped alignment of the coils 101 is made to lay over the top surface side of the adjacent coil, and the other side of the circumferential direction of the coils 101 is made to lay under the bottom surface side of the adjacent coil 101 so as to form mutually overlapping regions 101a in the thickness direction between adjacent coils 101;

a process where the columnar parts 34a2 are respectively inserted into interior of the mutually overlapping regions 101a; and a process where the plurality of coils 101, mutually overlapping in the thickness direction between adjacent coils 101, are inserted from the columnar parts 34a2 into the interior of the slots 102a of the stator cores 102.

Further, in the process for aligning the plurality of coils 101, the coils 101 are inclined in the same direction in the circumferential direction, and the coils 101 are moved to the central side in the radial direction.

In the process for pushing the plurality of coils 101, one coil 101 is pushed to span a plurality of teeth 102b of the stator core 102.

FIGS. 8A to 8D are schematic views for illustrating the coil alignment portion 120 according to another embodiment.

Note that FIGS. 8A and 8C are plan views for each process. FIG. 8B is a side view of a holding part 122 in FIG. 8A. FIG. 8D is a side view of a holding part 122 in FIG. 8C.

FIG. 9 is a schematic view for illustrating a transfer portion 123.

As illustrated in FIG. 8A, the coil alignment portion 120 is provided with an arm part 121 and a holding part 122.

A plurality of the arm part 121 is radially provided from the center of the coil alignment portion 120. Respective annular holding parts 122 are provided on the tip ends of the plurality of arm parts 121. The plurality of arm parts 121 are configured to be able to respectively extend toward and contract from the center of the coil alignment portion 120. Further, the plurality of arm parts 121 are configured to be able to respectively rotate. In other words, it is configured to be able to change positions in the radial direction of the holding parts 122 provided on the tip end of the arm parts 121 and to be able to incline the holding parts 122.

In other words, the coil alignment portion 120 has a plurality of arm parts 121 provided radially from the center and has a plurality of holding parts 122 provided respectively on the tip ends of the plurality of arm parts 121. The plurality of arm parts 121 respectively extends toward and contracts from the center of the coil alignment portion 120 and inclines the plurality of holding parts 122 in the same direction in the circumferential direction.

Next, an operation of the coil alignment portion 120 will be illustrated.

First, as illustrated in FIGS. 8A and 8B, the arm parts 121 are extended, the holding part 122 are horizontal, and the holding parts 122 are such that they do not overlap each other.

Next, the coils 101 are placed on each holding part 122 by the transfer part 22 or the like described above.

Next, as illustrated in FIGS. 8C and 8D, each of the holding parts 122 are inclined and the armed parts 121 are contracted such that mutually overlapping regions 101a are formed in the thickness direction between adjacent coils 101.

Next, as illustrated in FIG. 9, a coil 101 is received from each holding part 122 by the transfer portion 123. At this time, the set of coils 101 is received while holding a state in which mutually overlapping regions 101a are provided in the thickness direction between adjacent coils 101.

The transfer portion 123 may, for example, have a chuck part 123a that grasps each coil 101.

The transfer portion 123 passes the retrieved set of coils 101 to the insertion part 34a described above. According to the above, the set of coils 101 can be passed to the insertion part 34a while holding a state in which mutually overlapping regions 101a are provided in the thickness direction between adjacent coils 101.

FIGS. 10A to 10D are schematic views for illustrating the coil guide portion 225 (corresponding to one example of a second coil guide portion) according to another embodiment.

Note that FIGS. 10A and 10C are plan views for each process. FIG. 10B is a side view of the inclined plane 225b in FIG. 10A. FIG. 10D is a side view of the passing portion of the coil 101 in FIG. 10C.

Note that only a portion of the inclined plane 225b is depicted in order to avoid complexity.

As illustrated in FIG. 10A, the annular base section 225a and the inclined plane 225b are provided on the coil guide portion 225.

A hole 225c is provided in the center of the base section 225a for the insertion part 34a to pass through.

A plurality of the inclined plane 225b is radially provided from the center of the coil guide portion 225.

As illustrated in FIG. 10B, the inclined plane 225b is inclined in the direction where the central side of the coil guide portion 225 lowers in the radial direction. Moreover, the inclined plane 225B, similar to the inclined plane 25b1 described above, inclines in the same direction in the circumferential direction of the coil guide portion 225.

In other words, the coil guide portion 225 has a plurality of inclined planes 225b, inclining in the same direction in the circumferential direction and inclining in the direction where the central side is lower in the radial direction.

Next, an operation of the coil guide portion 225 will be illustrated.

First, as illustrated in FIGS. 10A and 10B, the coils 101 are successively placed on each inclined plane 225b by the transfer part 22 or the like described above.

Then, as illustrated in FIG. 10C, the placed coils 101 slide on the inclined plane 225b and align on the central side of the coil guide portion 225. At this time, mutually overlapping regions 101a are provided in the thickness direction between adjacent coils 101.

Next, as illustrated in FIGS. 10C and 10D, the insertion part 34a is raised and the set of coils 101 is passed while holding an aligned state with the columnar parts 34a2 of the insertion part 34a.

According to the above, the set of coils 101 can be passed to the insertion part 34a while holding a state in which mutually overlapping regions 101a are provided in the thickness direction between adjacent coils 101.

FIGS. 11A to 11C are schematic views for illustrating the coil alignment portion 220 according to another embodiment.

FIGS. 11A and 11C are plan views for each process. FIG. 11B is a side view of the inclined section 325b in FIG. 11A. FIG. 11D is a schematic view for illustrating a process for aligning the coils 101.

Note that only a portion of the inclined section 325b is depicted in order to avoid complexity.

As illustrated in FIGS. 11A and 11C, a coil guide portion 325 (corresponds to one example of the first coil guide portion) and a pull-in portion 326 are provided on the coil alignment portion 220.

As illustrated in FIG. 11A, the annular base section 325a and the inclined section 325b are provided on the coil guide portion 325.

A hole 325c is provided in the center of the base section 325a for the insertion part 34a to pass through. Similar to the inclined plane 225b illustrated in FIG. 10A, the inclined section 325b inclines in the same direction in the circumferential direction of the coil guide portion 325. However, the inclined section 325b is not required to incline in the direction where the central side of the coil guide portion 325 lowers in the radial direction.

As illustrated in FIG. 11C, a linear object 326a and a winding portion 326b are provided on the pull-in portion 326.

The linear object 326a may be made so as to have flexibility. The linear object 326a may be, for example, a string or the like formed of resin or the like.

The winding portion 326b has an annular shape and is provided with a guide hole 326c that the linear object 326a passes through. In the central portion of the winding portion 326b, a drive part 326d is provided that has a bobbin for winding the linear object 326a and/or an electric motor or the like.

In other words, the coil alignment portion 220 is provided with the pull-in portion 326 that pulls the linear object 326a that is passed through the inside of loops of a plurality of coils 101, to the central side of the coil guide portion 325.

Next, an operation of the coil alignment portion 220 will be described.

First, as illustrated in FIGS. 11A and 11B, the coils 101 are successively placed on each inclined section 325b by the transfer part 22 or the like described above.

Subsequently, the linear object 326a passes through the inside of the loop of each coil 101 where both ends of the linear object 326a are joined to make a ring-shaped linear object 326a.

Note that both ends of the linear object 326a may not be joined.

Next, as illustrated in FIG. 11C, the linear object 326a is set in the pull-in portion 326. Subsequently, the linear object 326a is pulled by the pull-in portion 326 to the central side of the coil guide portion 325.

In other words, by reducing the size of the ring-shaped loop, the linear object 326a is pulled to the central side of the coil guide portion 325 while maintaining a state in which mutually overlapping regions 101a are provided in the thickness direction between adjacent coils 101.

Next, the insertion part 34a is raised and the set of coils 101 is passed while holding an aligned state with the columnar parts 34a2 of the insertion part 34a.

According to the above, the set of coils 101 can be passed to the insertion part 34a while holding a state in which mutually overlapping regions 101a are provided in the thickness direction between adjacent coils 101.

According to the embodiments illustrated above, an assembly machine of a rotating electrical machine that can improve production efficiency, and a method for manufacturing the rotating electrical machine, can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An assembly machine of a rotating electrical machine comprising:
a coil alignment portion that aligns a plurality of coils, when aligning the plurality of coils in a ring shape, such that one side of a circumferential direction in the ring shaped alignment of the coils is made to lay over a top surface side of an adjacent coil, and the other side of the circumferential direction of the coils is made to lay under a bottom surface side of an adjacent coil so as to form mutually overlapping regions in a thickness direction between the adjacent coils;
an insertion part having a plurality of columnar parts inserted into the interior of the mutually overlapping regions; and
a pressing part which inserts the insertion part in an axial direction thereof so as to push the plurality of coils, mutually overlapping in the thickness direction between the adjacent coils, from the insertion part into the interior of a slot in the core of the rotating electrical machine.

2. The assembly machine of a rotating electrical machine according to claim 1, wherein the coil alignment portion is provided with a first coil guide portion that has a plurality of inclined planes, inclining in the same direction in the circumferential direction, where the coils are placed.

3. The assembly machine of a rotating electrical machine according to claim 2, wherein the first coil guide portion further includes a guide plane provided on a bottom end of each of the plurality of inclined planes and that supports the coil placed on the inclined plane.

4. The assembly machine of a rotating electrical machine according to claim 2, wherein a position in a height direction of the coil placed on the inclined plane at a bottom end side of the inclined plane is lower than a position in the height direction of the coil placed on the adjacent inclined plane at the top end side of the adjacent inclined plane.

5. The assembly machine of a rotating electrical machine according to claim 1, wherein the coil alignment portion has a plurality of arm parts provided radially from a center of the coil alignment portion and has a plurality of holding parts provided respectively on the tip ends of the plurality of arm parts; and
the plurality of arm parts respectively extend toward and contract from the center to incline the plurality of holding parts in the same direction in the circumferential direction.

6. The assembly machine of a rotating electrical machine according to claim 5, wherein the holding part has a ring shape.

7. The assembly machine of a rotating electrical machine according to claim 1, wherein the coil alignment portion is provided with a second coil guide portion that has a plurality of inclined planes inclining in the same direction in the circumferential direction and inclining in a direction such that the central side is lower in a radial direction of the coil alignment portion.

8. The assembly machine of a rotating electrical machine according to claim 7, wherein the inclined planes are provided radially from the center of the second coil guide portion.

9. The assembly machine of a rotating electrical machine according to claim 2, wherein the coil alignment portion is further provided with a pull-in portion that pulls a linear object, passed through the inside of a loop of the plurality of coils, to the central side of the first coil guide portion.

10. The assembly machine of a rotating electrical machine according to claim 9, wherein the linear object has flexibility.

11. The assembly machine of a rotating electrical machine according to claim 1, wherein the columnar part is provided in a position that faces a tip end section of teeth of the core.

12. The assembly machine of a rotating electrical machine according to claim 1, wherein the columnar part has a cylindrical shape and has a mating face on a tip end side.

13. The assembly machine of a rotating electrical machine according to claim 12, wherein the mating face is provided in a position that faces a tip end section of teeth of the core.

14. The assembly machine of a rotating electrical machine according to claim 1, wherein a number of the columnar parts is the same as a number of the teeth in the core.

15. A method for manufacturing a rotating electrical machine, comprising:
aligning the plurality of coils, when aligning a plurality of coils in a ring shape, such that one side of a circumferential direction in the ring shaped alignment of the coils is made to lay over a top surface side of an adjacent coil, and the other side of the circumferential direction of the coils is made to lay under a bottom surface side of an adjacent coil so as to form mutually overlapping regions in a thickness direction between the adjacent coils;
inserting columnar parts respectively into an interior of the mutually overlapping regions; and
pushing the plurality of coils, mutually overlapping in the thickness direction between the adjacent coils, from the columnar part into the interior of a slot in a core of the rotating electrical machine.

16. The method according to claim 15, wherein, in the aligning the plurality of coils, the plurality of coils are inclined in the same direction in the circumferential direction and the plurality of coils are respectively moved to a central side in a radial direction.

17. The method according to claim 16, wherein, in the aligning the plurality of coils, the plurality of coils are pushed one at a time to the central side in the radial direction.

18. The method according to claim 15, wherein, in the aligning the plurality of coils, a plurality of arm parts that respectively hold the plurality of coils are inclined in the same direction in the circumferential direction and the plurality of arm parts respectively contract toward a central side in a radial direction.

19. The method according to claim 15, wherein, in the aligning the plurality of coils, the plurality of coils are inclined in the same direction in the circumferential direction and the plurality of coils are respectively moved to a central side in a radial direction by pulling a linear object, passed through an inside of a loop of the plurality of coils, to the central side in the radial direction.

20. The method according to claim 15, wherein, in the pushing the plurality of coils, one of the coils is pushed to span a plurality of teeth in the core.
